(19) United States
(12) Patent Application Publication
(10) Pub. No.: US 2005/0281992 A1
(43) Pub. Date: Dec. 22, 2005

(54) Reflecting mark having anti-counterfeit arrangment

(76) Inventor: Chiu-Lang Lin, Taipei (TW)

Correspondence Address: Chiu-Lang Lin;4Fl., No. 27, Lane 160, Hsin Sheng S. Rd., Sec. 1, Taipei, 100, TW

(21) Appl. No.: 10/871,888

(22) Filed: Jun. 21, 2004

(51) Int. Cl. B32B 3/00; B32B 5/16

(52) U.S. Cl. 428/204

(57) ABSTRACT

A reflecting mark for anti-counterfeit is provided. The reflecting mark comprises a top transparent film having a top corrugated surface, a bottom reflecting layer disposed under the film, and a figure layer disposed between the film and the reflecting layer. The figure layer comprises at least six layers each having a figure formed thereon. The figures are aligned. Each figure has a color formed by mixing two or more components of cyan (or green), magenta, yellow, and black together. For example, a CIS bearing the reflecting mark can be easily identified by people, thereby eliminating confusion in distinguishing a genuine CIS from a counterfeit one.

### BACKGROUND OF THE INVENTION

1. Field of the Invention

The present invention relates to reflective arrangements and more particularly to a reflecting mark (e.g., CIS (corporate identity symbol), logo, trademark, etc.) having an improved anti-counterfeit arrangement.

2. Description of Related Art

It is often that a mark (e.g., CIS, logo, trademark, etc.) is printed or adhered on a product to be sold. It is also often found that one product bearing a mark having a similar appearance to another product is sold in the market. This can cause confusion among consumers. Thus, marks having an anti-counterfeit design are devised. One typical type of such marks is sticker having a mark printed by laser.

A conventional reflecting logo is shown in FIGS. 1 and 2. It comprises a top transparent film A having a top corrugated surface, a bottom reflecting layer C, and a plurality of figures (two are shown) B sandwiched between the film A and the reflecting layer C. A person may see different appearances of the logo by viewing in different angles. However, a person can see at most 4 different appearances of the logo due to technological limitations of the film A and the figures B. In fact, stickers having such reflecting logo printed thereon are only used as decorative members rather than as marks having an anti-counterfeiting design. Thus, the need for improvement still exists.

### SUMMARY OF THE INVENTION

It is an object of the present invention to provide a reflecting mark for anti-counterfeit comprising a top transparent film having a top corrugated surface; a bottom reflecting layer disposed under the film; and a figure layer disposed between the film and the reflecting layer; wherein the figure layer comprises at least six layers each having a figure formed thereon, the figures are aligned, and each figure has a color formed by mixing two or more components of cyan (or green), magenta, yellow, and black together. By utilizing the present invention, for example, a CIS can be easily identified by people, thereby eliminating confusion in distinguishing a genuine CIS from a counterfeit one.

The above and other objects, features and advantages of the present invention will become apparent from the following detailed description taken with the accompanying drawings.

### BRIEF DESCRIPTION OF THE DRAWINGS

FIG. 1 is a sectional view of three separate components of a conventional reflecting logo;

FIG. 2 is a perspective view of the figures formed on the reflecting layer of FIG. 1;

FIG. 3 depicts an exploded perspective view of preferred embodiment of reflecting mark according to the invention, where respective components of the figure layer and the reflecting layer are separate for illustration the structure of the reflecting mark; and

FIG. 3A is a greatly enlarged view of the area in circle A of FIG. 3.

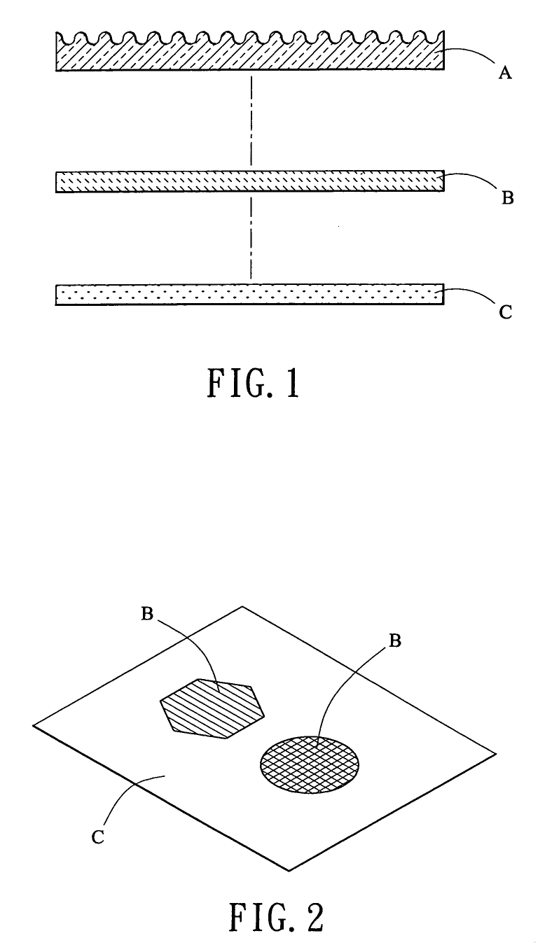

### DETAILED DESCRIPTION OF THE PREFERRED EMBODIMENTS

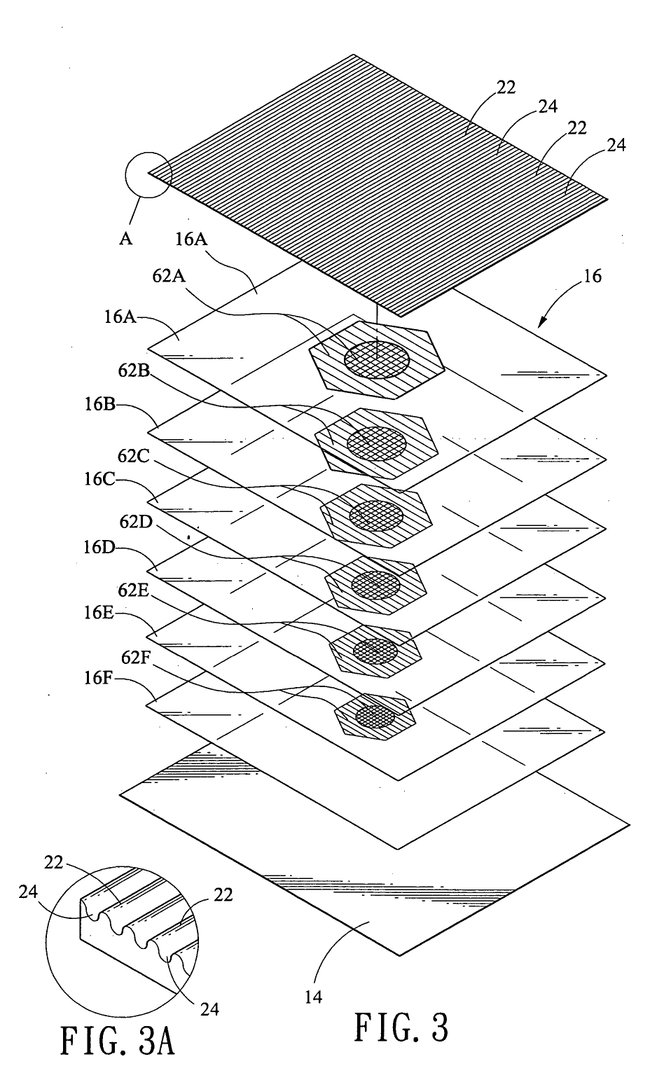

Referring to FIGS. 3 and 3A, there is shown a reflecting mark constructed in accordance with the invention comprising a top transparent film 12 having a top corrugated surface including a plurality of parallel grooves 24 and ridges 22; a bottom reflecting layer 14 for throwing back light incident from the film 12 (preferably, the reflecting layer 14 is white); and a figure layer 16 adhered and sandwiched between the film 12 and the reflecting layer 14 by utilizing a printing technique. The figure layer 16 comprises at least six layers (layers 16A, 16B, 16C, 16D, 16E, and 16F are shown). Each layer, for example, 16A comprises a FIG. 62A. Also, the FIGS. 62A to 62F are aligned in center portion and the areas of the figures are decreased gradually from the top FIG. 62A to the bottom FIG. 62F (or the areas of the figures are decreased gradually from the bottom figure to the top figure.) for presenting a strong visual effect. Further, the color of each of the FIGS. 62A to 62F is formed by mixing two or more components of cyan (or green), magenta, yellow, and black together.

Thus, a person may see six different appearances of the mark by viewing in different angles as compared to at most 4 different appearances of the mark experienced in the prior art. Hence, for example, a sticker, CIS, logo, or trademark bearing the mark of the invention can be easily identified by consumers, thereby eliminating confusion in distinguishing a genuine product from a counterfeit one.

While the invention herein disclosed has been described by means of specific embodiments, numerous modifications and variations could be made thereto by those skilled in the art without departing from the scope and spirit of the invention set forth in the claims.

1. A reflecting mark for anti-counterfeit comprising:
a top transparent film having a top corrugated surface;
a bottom reflecting layer disposed under the film; and
a figure layer disposed between the film and the reflecting layer;
wherein the figure layer comprises at least six layers each having a figure formed thereon.

2. The reflecting mark of claim 1, wherein the figures have the same content but different in size.

3. The reflecting mark of claim 1, wherein the figures are aligned in a center portion.

4. The reflecting mark of claim 3, wherein the areas of the figures are decreased gradually from the top figure to the bottom figure.

5. The reflecting mark of claim 3, wherein the areas of the figures are decreased gradually from the bottom figure to the top figure.

6. The reflecting mark of claim 1, wherein the film and the figure layer are formed together by printing.

7. The reflecting mark of claim 1, wherein the reflecting layer and the figure layer are formed together by printing.

8. The reflecting mark of claim 1, wherein each of the figures has a color formed by mixing two or more components of cyan, magenta, yellow, and black together.

9. The reflecting mark of claim 1, wherein each of the figures has a color formed by mixing two or more components of cyan, magenta, yellow, and black together.

10. The reflecting mark of claim 1, wherein the reflecting layer is white.
